(19) United States
(12) Patent Application Publication
(10) Pub. No.: US 2015/0317170 A1
(43) Pub. Date: Nov. 5, 2015

(54) MODULAR ELECTRONICS BOARD AND METHODS OF CONFIGURING AND OPERATING THE SAME

(71) Applicant: STRATTEC Advanced Logic, Milwaukee, WI (US)

(72) Inventor: Kevin Henderson, Davenport, FL (US)

(21) Appl. No.: 14/701,133

(22) Filed: Apr. 30, 2015

Related U.S. Application Data
(60) Provisional application No. 61/986,693, filed on Apr. 30, 2014.

(51) Int. Cl. G06F 9/445; G06F 3/0484

(52) U.S. Cl. CPC G06F 9/44505; G06F 3/04842

(57) ABSTRACT

Systems and methods for building an electronic device. One system includes a circuit board. A master controller and a plurality of modules are secured to the circuit board. Each of the plurality of modules is associated with manually-operable selection mechanism that allows the module to be placed in an active state or a deactivated state. The master controller can be configured to automatically identify a subset of the plurality of modules placed in the active state and to communicate with a software application executed on an external computing device to output identifying information for the subset of the plurality of modules to the software application. The master controller can also be configured to receive a configuration file from the software application, parse the configuration file, and transmit configuration data to each module included in the subset of the plurality of modules based at least in part on the parsed configuration file.

### RELATED APPLICATIONS

This application claims priority to U.S. Provisional Application No. 61/986,693, filed Apr. 30, 2014, the entire contents of which are incorporated by reference herein.

### FIELD

Embodiments of the present invention relate to modular electronics boards and methods for configuring and operating such boards.

### BACKGROUND

Manufacturers typically spend considerable time designing and engineering a product to achieve particular functionality and to meet desired specifications. Accordingly, if changes to a product are needed by a manufacturer during or after the development process, the manufacturer typically has to re-perform many aspects of the development process. The time and resources required to re-perform this work may prohibit the changes from being made or from being made in a timely manner. Therefore, even small changes can drastically impact the product development process. This impact is even more problematic in products having electronic systems that must also be reconfigured or re-designed as a result of the change(s) to the products. Accordingly, innovations in electronic systems that improve the process of product manufacturing and design continue to be welcome additions to the art.

### SUMMARY

Some embodiments of the present invention provide systems and methods for building an electronic device using an electronics board including a plurality of modules. In some embodiments, the electronics board also includes a master controller configured to automatically detect at least one of the plurality of modules as being active and to report the detected module(s) to a configuration application. The configuration application is configured to obtain configuration data from a user and generate a configuration file. The configuration application transmits the configuration file to the electronics board. The configuration file can include a text file that specifies operating parameters for each module from among pre-defined operations and parameter options.

For example, one embodiment of the invention provides a system for building an electronic device. The system includes a circuit board, a master controller secured to the circuit board, and a plurality of modules secured to the circuit board. Each of the plurality of modules is associated with a manually-operable selection mechanism that allows the module to be placed in an active state or a deactivated state. The master controller is configured to automatically identify a subset of the plurality of modules, the subset of the plurality of modules including each of the plurality of modules placed in the active state. The master controller is also configured to communicate with a software application executed on an external computing device to output identifying information for the subset of the plurality of modules to the software application and to receive a configuration file from the software application. In addition, the master controller is configured to parse the configuration file and transmit configuration data to each module included in the subset of the plurality of modules based at least in part on the parsed configuration file.

Another embodiment of the invention provides a method of building an electronic device. The method includes receiving, with a configuration application, an identifier of each of a plurality of modules secured to a circuit board manually activated using a selection mechanism associated each of the plurality of modules. The method also includes generating, with the configuration application, a user interface and displaying within the user interface the plurality of modules and a set of predetermined functions associated with each of the plurality of modules, and receiving, with the configuration application, a selection of at least one function from the set of predetermined functions for each of the plurality of modules from a user. In addition, the method includes generating, with the configuration application, a configuration file based at least in part on the at least one function selected for each of the plurality of modules and transmitting the configuration file to the plurality of modules.

Yet another embodiment of the invention provides a method of building an electronic device. The method includes displaying, with a software application, a list of available projects for a circuit board including a plurality of modules configured to be manually activated and deactivated using a selection mechanism associated with each of the plurality of modules, and receiving, with the software application, a selection of a project from the list of available projects from a user. The method also includes prompting, with the software application, the user for parameters for the selected project, and automatically determining, with the software application, a subset of the plurality of modules to be activated for the selected project based at least in part on the parameters for the selected project. In addition, the method includes displaying the subset of the plurality of modules, with the software application, to the user.

Other aspects of the invention will become apparent by consideration of the detailed description and accompanying drawings.

### BRIEF DESCRIPTION OF THE DRAWINGS

FIG. 1 schematically illustrates a system for building an electronic device.

FIG. 2 is a flow chart illustrating a method of using the system of FIG. 1.

FIGS. 3-8 are screen shots illustrating a user interface for initializing a project using the system of FIG. 1.

### DETAILED DESCRIPTION

Before embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

It should also be noted that a plurality of hardware and software based devices, as well as a plurality of different structural components, may be utilized to implement the invention. A plurality of hardware and software based devices, as well as a plurality of different structural components, may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components, may be utilized to implement the invention. For example, “control units” and “controllers” described in the specification can include one or more processors, one or more memory modules including non-transitory computer-readable medium, one or more input/output interfaces, and various connections (e.g., a system bus) connecting the components.

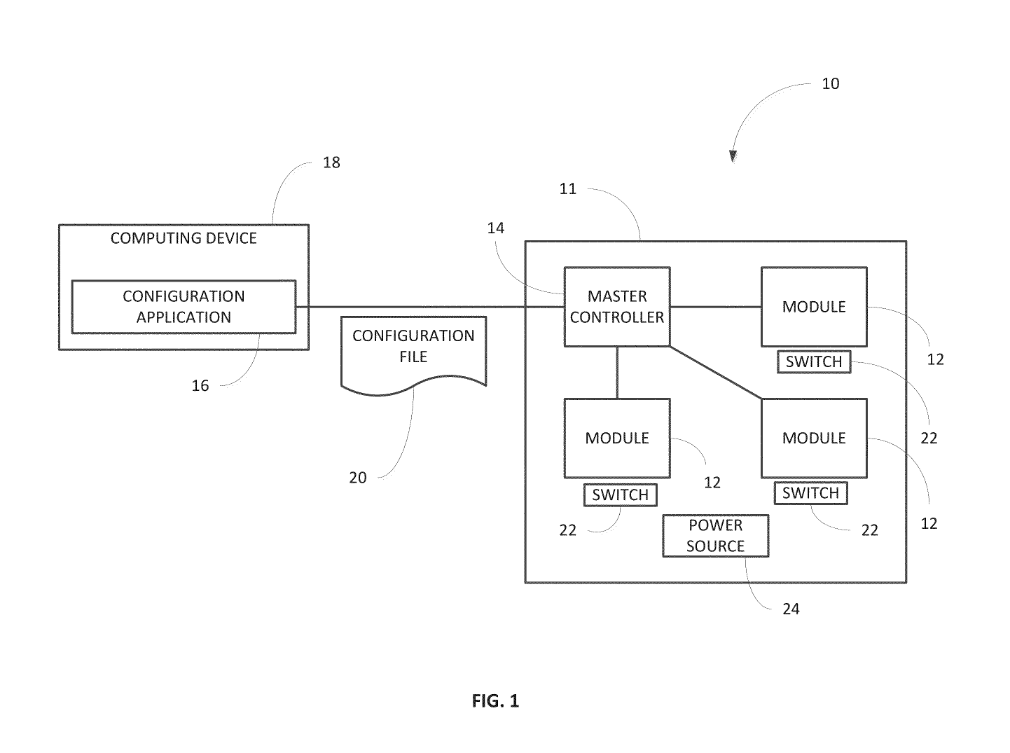

FIG. 1 illustrates a system 10 for building an electronic device or system. The system 10 includes an electronics board 11 (e.g., a circuit board, such as a printed circuit board (“PCB”)). The electronics board 11 includes a plurality of modules 12 (e.g., electronic boards, such as PCBs, including microprocessor(s) and other electronic components) secured to the board 11. The system 10 also includes a master controller 14 (e.g., a PCB) secured to the board 11. The master controller 14 is configured to communicate with each of the plurality of modules 12. In some embodiments, to form the electronics board 11 the master controller 14 and the plurality of modules 12 are connected to a common PCB.

The plurality of modules 12 can include a combination of one or more of a display board (e.g., liquid crystal display, an organic LED (“OLED”) display, etc.), control board (e.g., a solenoid control board, a relay control board, a motor control board, a motor with encoded board, etc.), a biometric authentication board (e.g., a fingerprint scanner board, retinal scanner board, etc.), a wireless communication board (e.g., Z-Wave, which operates at approximately 900 MHz, Wi-Fi, which operates at approximately 2.4 GHz and approximately 5 GHz, Bluetooth, which operates at approximately 2.4 to 2.485 GHz, etc.), a wired communication board (e.g., Ethernet or USB), a power board (e.g., a super capacitor board, a power over Ethernet (“PoE”) board, etc.), a user interface board (e.g., a button control module, keypad module, etc.), a sensor board (e.g., an infrared or passive infrared board), and other input and/or output boards (e.g., a camera board, a speaker and/or audio board, a microphone board, a gyroscope board, a reflective touch LCD board, a non-reflective touch LCD board, and the like). It should be understood that although only three modules 12 are illustrated in FIG. 1, the electronics board 11 can include more or less modules 12.

In some embodiments, the electronics board 11 can be approximately 270 millimeters by 270 millimeters and can include a 2-layer PCB. The modules 12 connected to the board 11 can similarly include multiple layer PCBs and can be stacked using stacking pins.

The system 10 also includes a configuration application 16. The configuration application 16 is executed by an external computing device 18 (e.g., laptop computer, tablet computer, smartphone, smart watch, smart television, etc.) connectable to the master controller 14. The remote computing device 18 can be connected to the master controller 14 using a wired (e.g., a universal serial bus (“USB”) connection) or a wireless connection. As described in more detail below, the configuration application 16 is executable by a processor included in the remote computing device 18 and is configured to generate a user interface for receiving configuration data for the electronics board 11 and to generate a configuration file 20 for the electronics board 11.

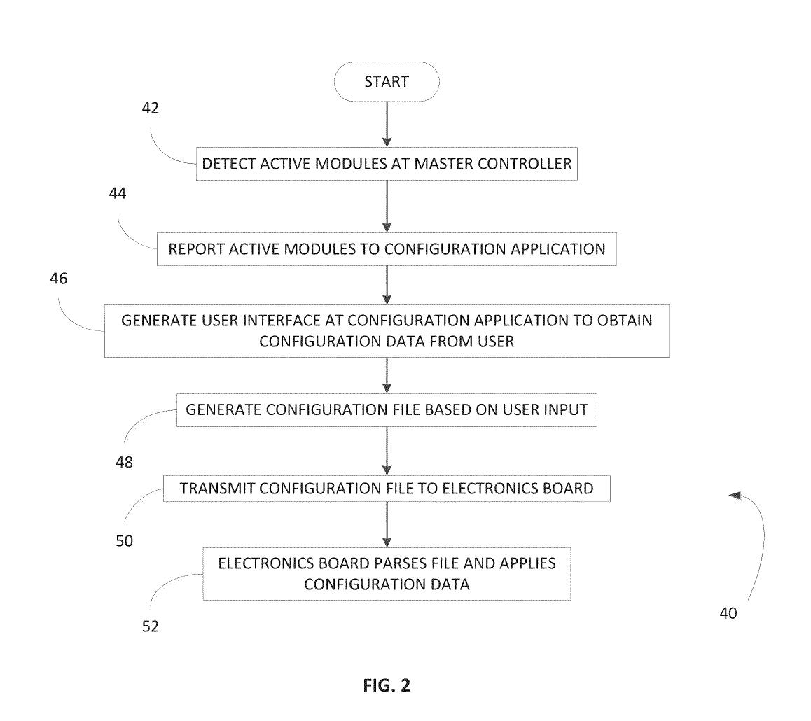

For example, FIG. 2 illustrates a method 40 of using the electronics board 11 to build an electronics device (e.g., a prototype device). As part of the method 40, the master controller 14 (e.g., when the master controller 14 powers up) automatically determines what modules 12 are connected to the master controller 14 or are otherwise powered on or active (at block 42). For example, in some embodiments, each module 12 is associated with a manually-operable selection mechanism 22 (e.g., a power dual in-line package (“DIP”) switch toggle, a physical button or virtual button (e.g., on a touchscreen), etc.). A user can select the selection mechanism 22 to turn on or activate the associated module 12 (and to turn off or deactivate the module 12 once activated). For example, a module 12 can default to a deactivated state (e.g., where the module 12 receives no power). To set the module 12 to an active state, the user can select the mechanism 22. In particular, in some embodiments, the selection mechanism 22 includes a power switch that has two positions: a first position and a second position. The first position can be associated with the activated state and the second position can be associated with the deactivated state.

Activating a module 12 can cause the module 12 to receive power from a power source 24 associated with the electronics board 11 (e.g., a battery and/or DC power through an AC-to-DC adapter connectable to the board 11 and an external power source, such as a power outlet). Accordingly, a user can use the selection mechanisms 22 to select one or more of the plurality of modules 12 as being “active” or “activated.” In some embodiments, each selection mechanism 22 can be associated with a display (e.g., a single light emitting diode (“LED”)) that informs the user whether the associated module 12 is currently “active.” For example, the display can provide a first output (e.g., light up) when power is being provided to the associated module 12 (i.e., the module 12 is activated) and can provide a second output (e.g., not light up) when power is not being provided to the associated module 12 (i.e., the module 12 is deactivated).

Accordingly, the master controller 14 can use the selection mechanism 22 associated with each module 12 to identify what modules 12 are currently active. In other embodiments, the master controller 14 can track power consumption to identify what modules 12 are currently active. In still other embodiments, the master controller 14 can ping each of the modules 12 and wait for a response signal to identify what modules 12 are currently activated.

After identifying what subset of the modules 12 is currently active (at block 42), the master controller 14 provides information to the configuration application 16 regarding active modules 12 (e.g., unique identifiers for the active modules 12) (at block 44). The configuration application 16 then generates a user interface that allows a user to input configuration data for configuring each currently-active module 12 (at block 46).

In some embodiments, each module 12 is programmed to perform a set of predetermined functions, and the configuration application 16 is configured to expose these functions to the user where the user can select functions, select a sequence of functions, and set operational parameters for the functions (e.g., time values, threshold values, message formats and content, etc.). For example, one or more of the modules 12 can be configured such that all of its predetermined internal functions are “variable” in nature (e.g., can be turned on and off and can apply different operational parameters). In particular, the configuration application 16 can generate a user interface that provides menu-driven options for functionality performed by the modules 12. Accordingly, the user interface can include a list or graphical illustration of the currently-active modules 12 and the predetermined functions available for each active module 12. A user of the configuration application 16 can then select the functions to be performed by the modules 12 and the operational parameters associated with the functions. Therefore, the configuration application 16 can allow a user to configure the electronics board 11 without requiring the user to perform any type of programming. For example, the user interface can prompt the user textually or graphically to receive the function selections, function sequences, and operational parameters in a textual or graphical form and without requiring that the user enter any object code. In particular, in some embodiments the user interface provided by the configuration application 16 allows a user to manipulate displays or menus provided on a display module secured to the electronics board 11.

For example, if a fingerprint scanning board is currently active, the predetermined functions associated with this module 12 can include performing a scan, and various features of such a scan (e.g., swipe speed, resolution, and the like). Similarly, if a LED board is currently active, the predetermined functions associated with this module 12 can include turning on the LED, turning off the LED, and/or changing a color of the LED. Using the set of predetermined functions for each active module 12, the user can build functionality for an electronic device by creating a sequence of selected functions and specifying operational parameters for the sequence of functions as needed.

After receiving the configuration data for the electronics board 11 from the user, the configuration application 16 generates the configuration file 20 as noted above (at 48). The configuration application 16 then transmits the configuration file 20 to the electronics board 11 (at block 50). For example, in some embodiments the configuration application 16 transmits the configuration file 20 to the master controller 14. In other embodiments, the configuration application 16 transmits the configuration file 20 directly to one or more of the modules 12. Also, in some embodiments, the configuration application 16 generates separate configuration files 20 for each module 12 and/or the master controller 14.

In some embodiments, the configuration file 20 includes a text file, and the portion of the electronics board 11 (e.g., the master controller 14 and/or one or more modules 12) is configured to parse the text file and apply configuration data included in the file accordingly (at block 52). For example, the text file can include data representing the functions, function sequences, and operational parameters selected by the user through the configuration application 16. For example, the text file can include identifiers of the functions selected for each of the currently-active modules 12 and the operational parameters specified by the user. Accordingly, the modules 12 use the parsed text file to identify what “variable” functions to perform, what sequence to perform the functions in, and the operational parameters for performing the functions.

Using the configuration file increases the speed and stability of configuring the electronics board 11. For example, conventional embedded devices are configured through a firmware upgrade. This process typically requires a programmer who has access to the source code to make the appropriate changes and to compile (and often test extensively for errors) a new version of the binaries. These binaries are then flashed into the end product. Accordingly, this process can be timely and can introduce errors (e.g., if an error occurs during the flashing process). In contrast, the master controller 14 and the modules 12 are flashed with static firmware that implements all of the variable functions. Accordingly, to upgrade or change the functionality the board 11, the configuration file 20 simply instructs the master controller 14 and modules 12 to perform particular functions, in particular sequences, and with particular operational parameters using the binaries already flashed into the electronics board 11. Therefore, configuring and re-configuring the electronics board 11 using the configuration file 20 allows changes to be made quickly and safely (e.g., if an error occurs during parsing of a configuration file 20, the file 20 simply needs to be resubmitted to the electronics board 11).

For example, as one example, a user can use the system 10 to build a garage door opener. In this application, the user can activate (e.g., using the selection mechanisms 22) a communication board (e.g., Z-Wave module), a user interface board (e.g., a button module), and a display board (e.g., a single line OLED display) included in the electronics board 11. Power is then provided to the electronics board 11. When the master controller 14 receives power, the master controller 14 becomes “aware” of the modules 12 that are active. The master controller 14 reports the active modules 12 to the configuration application 16, and the configuration application 16 generates a user interface that allows the user to configure the active modules 12. For example, the functions for the button module can include outputting a signal in response to a button press, the functions for the Z-Wave module can be receiving or sending a signal, and the functions for the OLED display can include turning on or flashing an OLED for a period of time. Accordingly, the user can use the configuration application 16 to specify that if the signal from the button module is received, the Z-Wave module should transmit a signal to the garage door and the display board should flash the OLED for 5 seconds.

Once the system 10 is configured, the user can use the system 10 as a prototype for a garage door opener (e.g., for testing and other purposes). The system 10 can also be used as a blueprint for a commercial version of the garage door opener. However, if a customer (e.g., a garage door manufacturer) desires a garage door opener that works on a Wi-Fi connection in addition to or in place of a Z-Wave connection, this functionality can be quickly added to the system 10 by activating (or connecting if not previously connected) a Wi-Fi communication board, turning on the board 11, connecting the board 11 to the computing device 18 hosting the configuration application 16, and re-configuring the electronics board 11. Similarly, if a customer desires a garage door opener that uses a touch screen rather than a number of buttons, the button module can be deactivated (or removed) and a touchscreen module (e.g., a LCD board) can be activated (and added if not previously included). The electronics board 11 can then be powered up, connected to the configuration application 16, and configured accordingly. Any of the modules 12 described above can similarly be activated and deactivated (and installed and removed as necessary) in a similar manner. This modular functionality of the electronics board 11 enables a user to quickly change a product and associated elements and functionality without expensive and time-consuming engineering and re-design of the product. In some embodiments, the electronics board 11 is pre-populated with a complete set of modules 12 that can be selectively and individually powered to define any combination of active modules 12 corresponding to any desired functionality of the system, even though one or more of the modules may never be used (i.e., powered) for any of desired systems. The ability to rapidly and easily adapt a complete pre-populated electronics board 11 by simply selecting the appropriate combination of switches 22 associated with the existing modules 12 enables a user to generate and assess new prototypes and products (including testing the functionality of such prototypes and products) with an efficiency that has not been possible to date.

Accordingly, in some embodiments, configuring the system requires no programmer, no programming, no potentially dangerous flashing process (e.g., interrupted flashing of a product's firmware often ruins the product), and can be performed with limited or minimal skills. Therefore, the system 10 allows a user to experiment with different functionality in almost real-time with little or no risk on the actual manufactured product. Thus, the system 10 allows a user to change features of a product (e.g., in real-time) during the manufacturing process. It also allows a user to test market potential product configurations (e.g., with customers) without going through the expense or time to actually engineer commercial products.

For example, in an application where a manufacturer is developing a door lock that drives a motor to open a latch after a user is authenticated, a parameter for motor operation can be how far the motor drives the latch in one or more directions. In such an application, the motor may not drive the latch a sufficient distance for a latching or unlatching operation, and/or may drive the latch too far for such an operation. To solve this problem, a manufacturer can generate a new configuration file 20 that sets new values for a parameter corresponding to the amount of movement of the latch (e.g., the amount the motor is driven after a user is authenticated). Accordingly, a manufacturer can address product deficiencies or changes quickly and easily using the configuration file 20. Similarly, if a user desires a product that allows for 50 different users rather than 5 different users as the product is currently configured, a manufacturer can generate a new configuration file 20 that increases the maximum number of users. As another example, if a user desires to use a personal identification number (“PIN”) for identification rather than biometrics (e.g., a fingerprint scanner), a manufacturer can generate a new configuration file 20 that looks solely to a keypad for authentication and ignores any biometrics. As yet another example, a manufacturer can generate a new configuration file 20 as described above to change a display (e.g., add a company's logo, change menu options, orders, etc.). Accordingly, in some embodiments, a manufacturer can quickly make these changes without forcing the manufacturer to perform any programming, binary file creation, or flashing.

As noted above, in some embodiments, the power source 24 for the electronics board 11 includes a battery. For example, in some embodiments, the electronics board 11 or components of the board 11 (e.g., a biometrics module) can be powered using four AA batteries. Other types and quantities of batteries, however, can also be used (e.g., lithium ion batteries, etc.). To prolong the life of the battery, a sleep mode can be used. In some embodiments, using the sleep mode allows the board 11 or a particular module 12 to operate for a much more extended period of time, such as approximately 6 months to a year (e.g., approximately 274 days of operation when the system is used approximately 5 times per day). For example, in some embodiments, the board 11 includes a circuit that has various levels of sleep. In effect, the longer the board 11 is not used, the deeper the sleep the board 11 enters. Also, in at least one level of sleep power can be completely turned off to the board 11 or portions thereof. Similarly, the board 11 can include a wake-up circuit that quickly recovers the board 11 from the deepest sleep level such that the sleep mode state is not perceptible or is hardly perceptible. For example, the wake-up circuit can power up the board 11 from the deepest sleep level and respond to user input in approximately the same amount of time it takes the board 11 to respond to user input in a fully-powered-up state.

The lower power capabilities of the electronics board 11 enable prolonged battery operation and battery backup capabilities. Accordingly, the battery configuration can be used to make hard-wired products wireless and, therefore, more flexible. Similarly, when using a battery back-up, the above described battery configuration can provide long-term battery backup (in effect, an integrated real-time uninterruptible power supply (“UPS”)) that provides continuous operation even when hard-wired power fails. For example, a door lock can use power over Ethernet (“POE”) and can recharge a lithium battery when the POE is supplying power. Therefore, if and when power to the door lock fails, the lock continues to operate in an uninterrupted manner using the charged lithium battery. Similarly, a door lock for a vehicle can use the above-described battery configuration to allow a user to unlock a door electronically even when the vehicle's main battery is dead. Furthermore, devices that require authentication (e.g., safes and cabinets) can be powered by the battery configuration to make the device more user-friendly, because a user is not required to plug the device in or to replace the batteries often.

In some embodiments, a software application (included in the configuration application 16 or separate from the configuration application 16) provides a user with guidance on what modules 12 to activate for a particular type of project (referred to as the “wizard application” in the present application). The wizard application can be executed on a computing device (e.g., the remote computing device) and can ask a user for details regarding a desired project for the electronics board 11. The wizard application can then instruct or suggest to the user what modules 12 to activate (and install if necessary) on the board 11 to implement the project. In some embodiments, the wizard application also informs or suggests to a user what functions to select when configuring the board 11 for the project, a sequence of the selected functions, and/or the operational parameters for the selected functions. Accordingly, a user can use this information when using the configuration application 16 to configure the board 11.

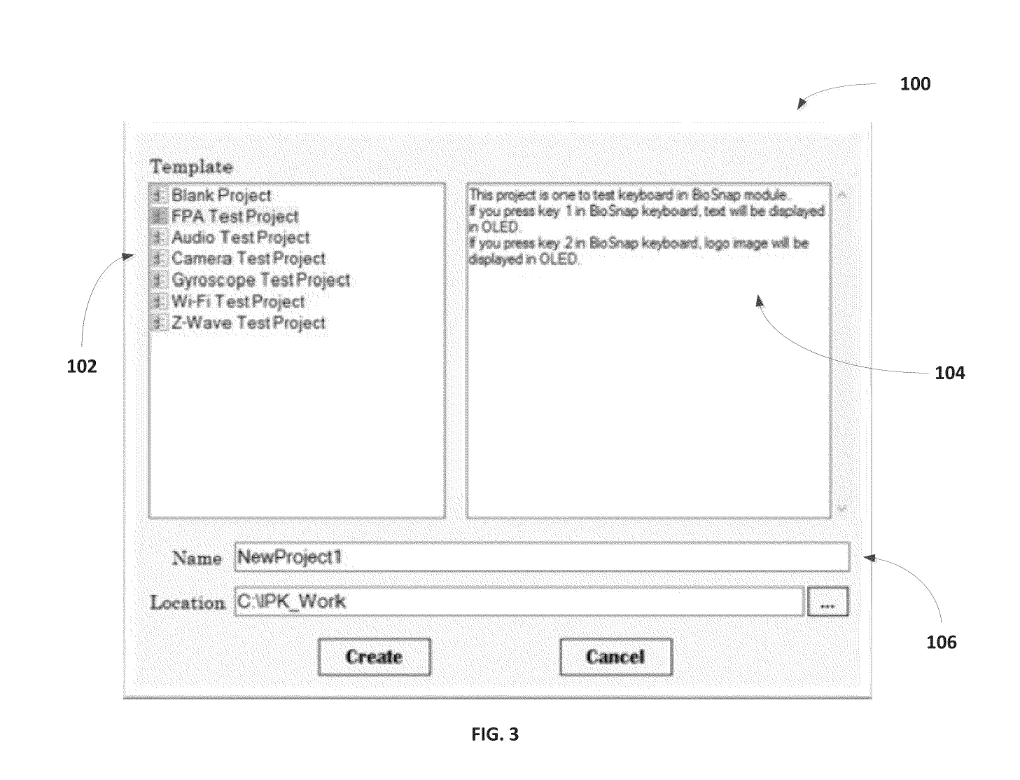

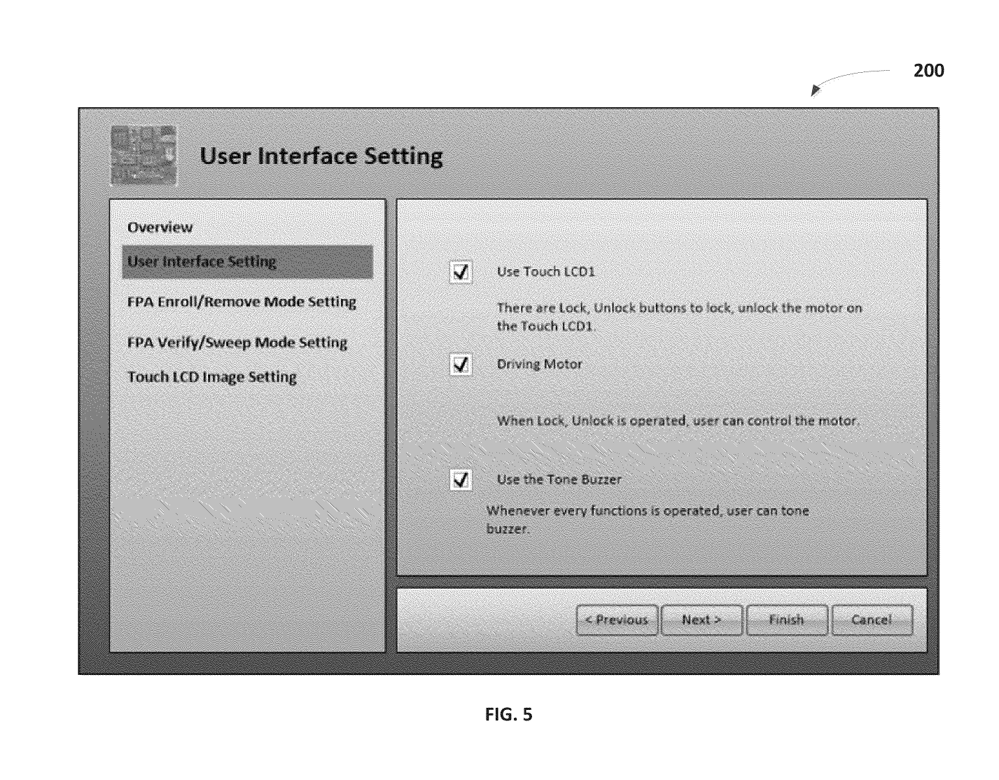

For example, FIGS. 3-5 are screen shots illustrating user interfaces generated by an example wizard application. In particular, FIG. 3 illustrates a user interface 100 that allows a user to select a project type. The user interface 100 can include a list of available projects 102 and, in some embodiments, can display a description 104 for each project included in the list of available projects 102. The description 104 provides an explanation of the project. The user interface 100 also includes an input mechanism 106 that allows a user to specify a name for a project selected from the list 102. In some embodiments, when a user uses the wizard application to set-up a new project, the wizard application generates a project file that is readable by the configuration application. Accordingly, after executing the wizard application, a user can load the project file generated by the wizard application into the configuration application 16 to finalize the configuration process for the board 11. Thus, the project file provides at least some of the configuration data otherwise entered by the user through the configuration application 16 to further simplify the configuration process for the board 11.

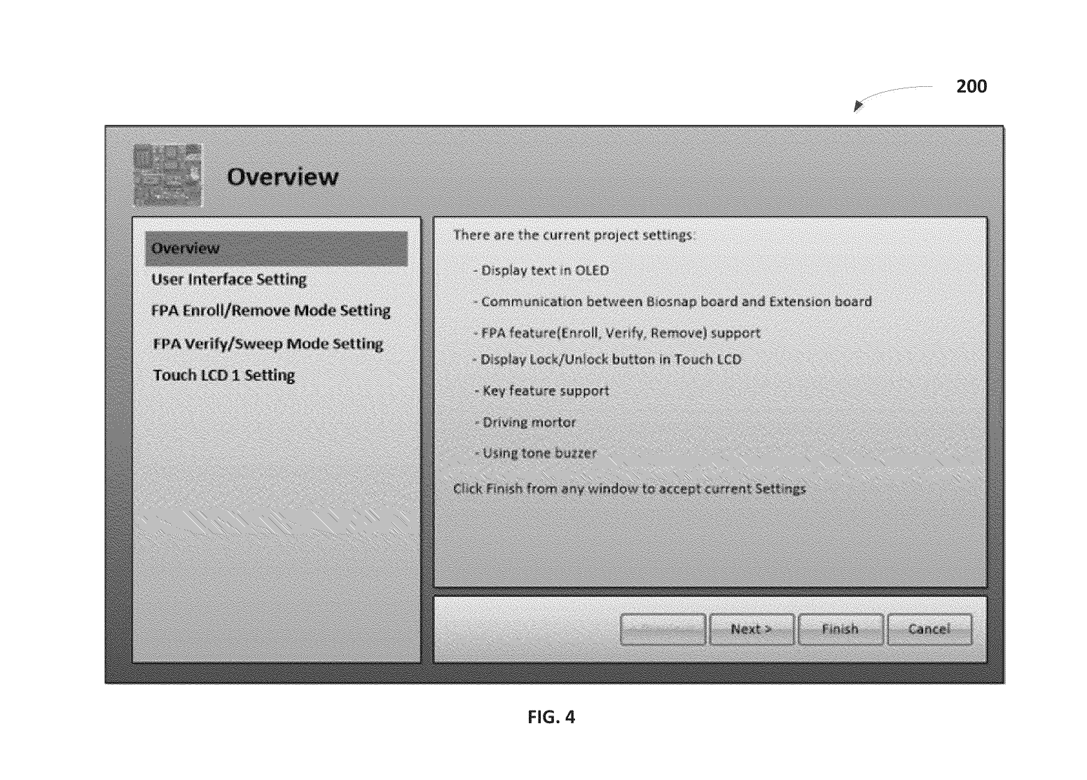

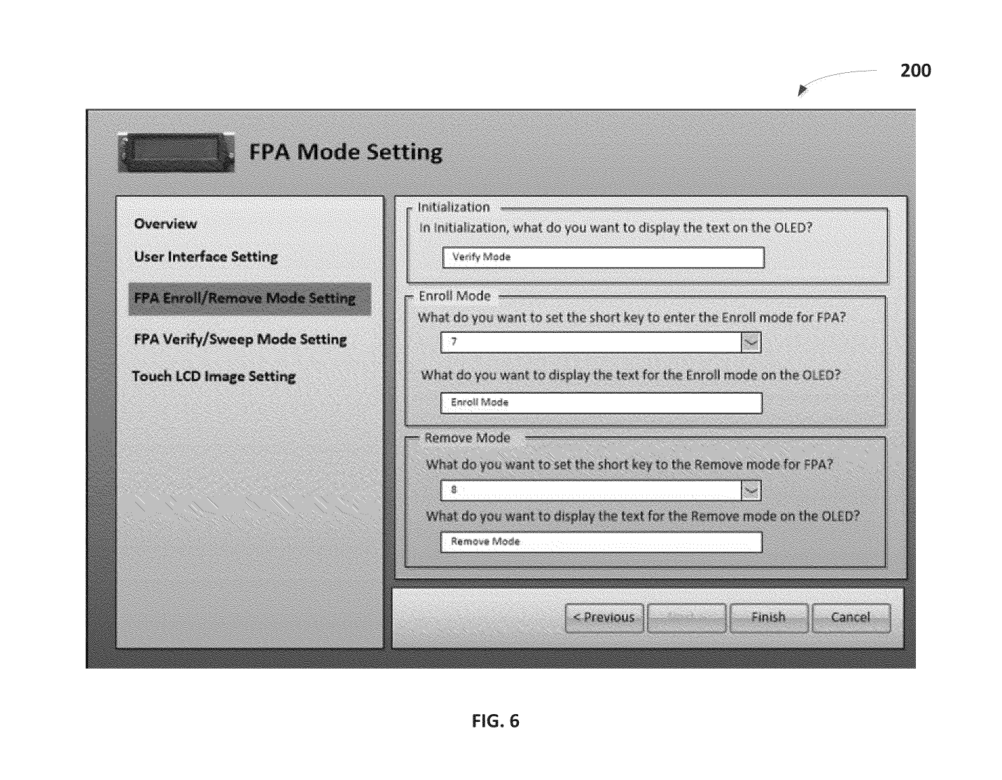

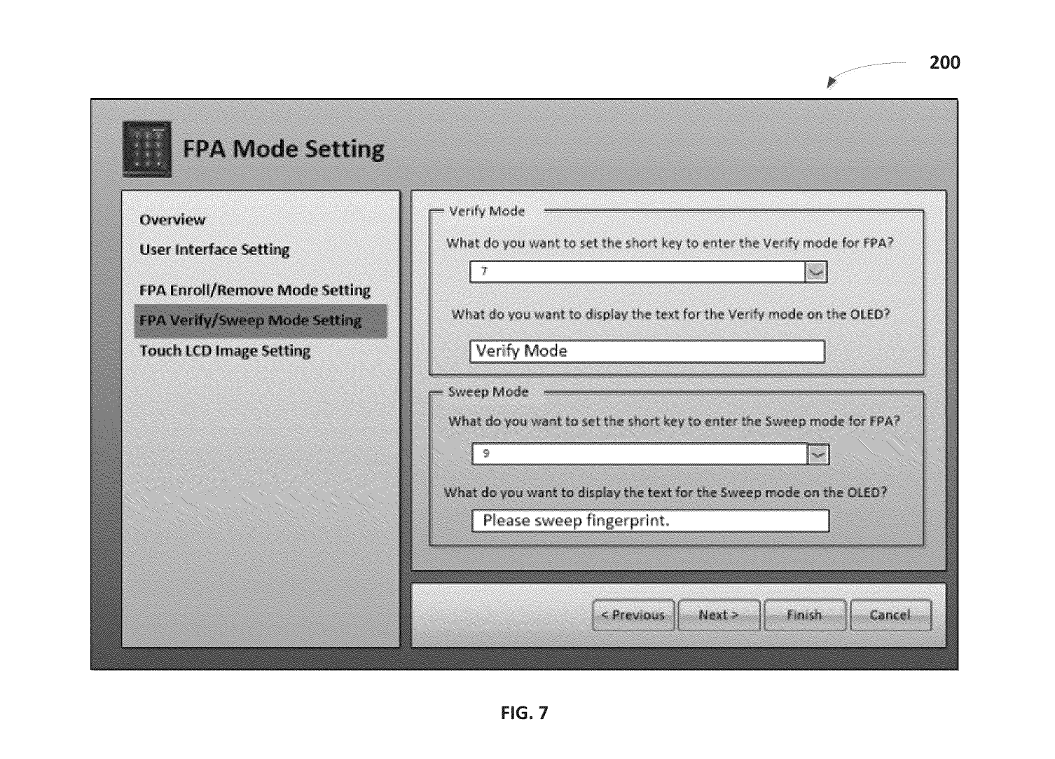

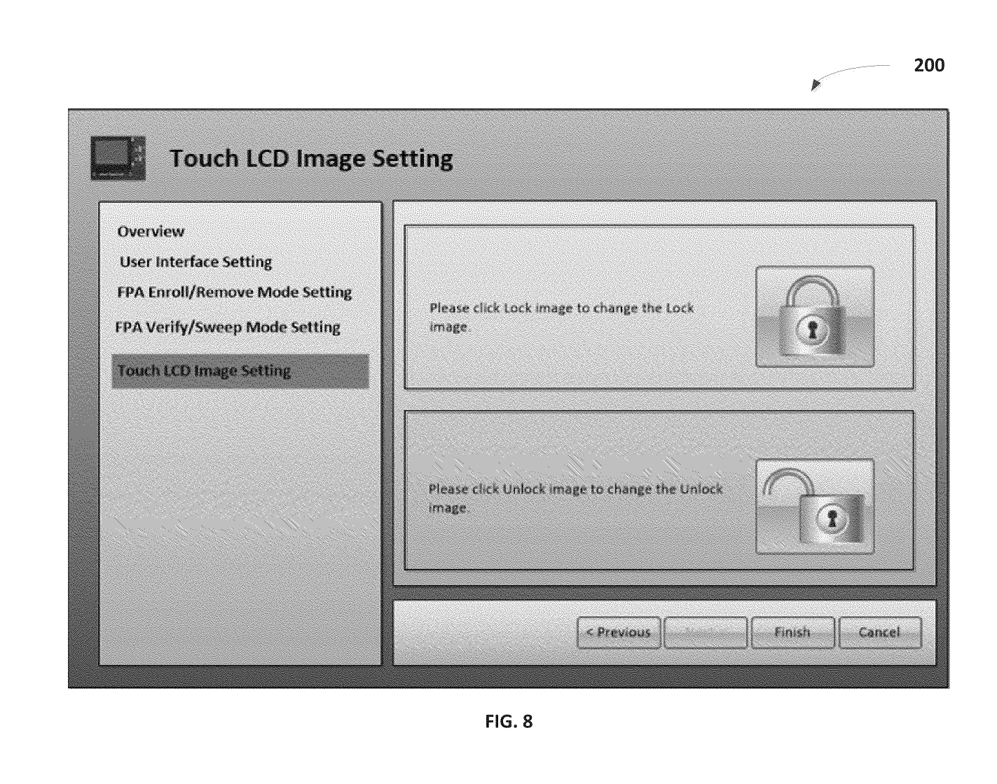

For example, if a user selects the fingerprint authentication (“FPA”) project from the list 102 of available projects within the user interface 100, the wizard application displays the user interfaces 200 illustrated in FIGS. 4-8 that prompt the user to make selections associated with the FPA project (e.g., what buttons are provided, whether a buzzer or other sound is generated when a function is performed, what text and/or images are displayed to the user, etc.). In some embodiments, after entering all of the prompts, the wizard application can display a list of modules 12 that the user should activate on the board 11 to implement the project based on the data the user entered into the wizard application. Accordingly, the user can use this information to activate the appropriate modules 12 (e.g., using the selection mechanisms 22) and then use the configuration application 16 to implement the FPA project. As noted above, in some embodiments, the wizard application generates a project file that can be used by the configuration application 16 to implement the FPA project. In other embodiments, the wizard application can be configured to provide instructions to the user regarding how to implement the FPA project using the configuration application 16.

It should be understood that in some embodiments, the functionality provided by the wizard application can be configured with the functionality provided by the configuration application. Accordingly, in some embodiments, the information provided by the user using the wizard application can be used to create a configuration file 20 as described above.

Thus, embodiments of the invention provide a programming-free method of developing electronic devices using a circuit board including a plurality of modules that can be enabled and disabled by a user. The software installed on the plurality of modules provides an interface to the functions programmed on each module, and allows a user to select and configure the functions to generate a particular electronic device using the circuit board. Once configured, the circuit board can be used as a prototype and blueprint for creating a commercial product. Accordingly, the methods and systems described herein can be used to quickly create prototypes prior to production and to make changes to the prototypes quickly and efficiently.

Various features of the invention are set forth in the following claims.

What is claimed is:

1. A system for building an electronic device, the system comprising:
a circuit board;
a master controller secured to the circuit board; and
a plurality of modules secured to the circuit board, wherein each of the plurality of modules is associated with manually-operable selection mechanism that allows the module to be placed in an active state or a deactivated state;
wherein the master controller is configured to automatically identify a subset of the plurality of modules, the subset of the plurality of modules including each of the plurality of modules placed in the active state,
wherein the master controller is also configured to communicate with a software application executed on an external computing device to output identifying information for the subset of the plurality of modules to the software application and to receive a configuration file from the software application,
wherein the master controller is configured to parse the configuration file and transmit configuration data to each module included in the subset of the plurality of modules based at least in part on the parsed configuration file.

2. The system of claim 1, wherein each of the plurality of modules is programmed to perform a plurality of functions, and the software application is configured to display the plurality of functions to a user through a user interface and allow the user to select at least one of the plurality of functions and specify operational parameters for the at least one of the plurality of functions through the user interface.

3. The system of claim 2, wherein the configuration data transmitted from the master controller includes an identifier of the at least one of the plurality of functions and the operational parameters.

4. The system of claim 1, wherein the selection mechanism associated with each of the plurality of modules includes a manually-operable switch having two positions, the two positions including a first position corresponding to the active state and a second position corresponding to the deactivated state.

5. The system of claim 1, wherein the configuration file includes a text file.

6. The system of claim 1, wherein the circuit board includes a power source that supplies power each of the plurality of modules.

7. The system of claim 6, wherein the power source is configured to supply power to one of the plurality of modules only when the one of the plurality of modules is in the active state.

8. The system of claim 1, wherein the master controller is configured to automatically identify the subset of the plurality of modules based at least in part on the selection mechanism associated with each of the plurality of modules.

9. The system of claim 1, wherein the master controller is configured to automatically identify the subset of the plurality of modules based at least in part on power consumption of each of the plurality of modules.

10. The system of claim 1, further comprising a display associated with each of the plurality of modules, the display providing a first output when the module is in the active state and providing a second output when the module is in the deactivated state.

11. A method of building an electronic device, the method comprising:
receiving, with a configuration application, an identifier of each of a plurality of modules secured to a circuit board manually activated using a selection mechanism associated each of the plurality of modules;
generating, with the configuration application, a user interface and displaying within the user interface the plurality of modules and a set of predetermined functions associated with each of the plurality of modules;
receiving, with the configuration application, a selection of at least one function from the set of predetermined functions for each of the plurality of modules from a user;
generating, with the configuration application, a configuration file based at least in part on the at least one function selected for each of the plurality of modules; and
transmitting the configuration file to the plurality of modules.

12. The method of claim 11, wherein transmitting the configuration file to the plurality of modules includes transmitting the configuration file to a master controller secured to the circuit board and configured to communicate with each of the plurality of modules, wherein the master controller is configured to parse the configuration file and transmit configuration data based at least in part on the parsed configuration file to each of the plurality of modules.

13. The method of claim 11, further comprising receiving operational parameters for the at least one function selected for each of the plurality of modules from the user.

14. The method of claim 11, wherein generating the configuration file includes generating a text file.

15. A method of building an electronic device, the method comprising:
displaying, with a software application, a list of available projects for a circuit board including a plurality of modules configured to be manually activated and deactivated using a selection mechanism associated with each of the plurality of modules;
receiving, with the software application, a selection of a project from the list of available projects from a user;
prompting, with the software application, the user for parameters for the selected project;
automatically determining, with the software application, a subset of the plurality of modules to be activated for the selected project based at least in part on the parameters for the selected project; and
displaying the subset of the plurality of modules, with the software application, to the user.

16. The method of claim 15, further comprising providing data based on the selected project and the parameters for the selected project to a configuration application, the configuration application configured to generate and transmit a configuration file to the subset of the plurality of modules.

17. The method of claim 15, further comprising generating a configuration file and transmitting the configuration file to the subset of the plurality of modules.

18. The method of claim 17, wherein generating the configuration file includes generating a text file.

19. The method of claim 17, wherein generating the configuration file includes generating a file that includes an identifier of at least one function preprogrammed for each module included in the subset of the plurality of modules and operational parameter for the at least one function.
